(19) United States
(12) Patent Application Publication
(10) Pub. No.: US 2019/0315368 A1
(43) Pub. Date: Oct. 17, 2019

(54) ASSISTED DRIVING METHOD AND APPARATUS, COMPUTING DEVICE, COMPUTER READABLE STORAGE MEDIUM AND COMPUTER PROGRAM PRODUCT

(71) Applicant: BOE TECHNOLOGY GROUP CO., LTD., Beijing (CN)

(72) Inventors: Yan SHEN, Beijing (CN); Hongli WANG, Beijing (CN); Xingxing ZHAO, Beijing (CN)

(21) Appl. No.: 16/240,866

(22) Filed: Jan. 7, 2019

(30) Foreign Application Priority Data
Apr. 13, 2018 (CN) 201810332626.0

(51) Int. Cl. B60W 40/06; B60W 50/14; B60W 50/12; G06K 9/00

(52) U.S. Cl. CPC B60W 40/06; B60W 50/14; B60W 2050/146; G06K 9/00798; B60W 50/12

(57) ABSTRACT

An assisted driving method and apparatus, a computing device, a computer readable storage medium and a computer program product. The assisted driving method includes: acquiring a first image of a current road section, wherein in the first image is recorded road image information of the current road section; and controlling appropriate playback of the acquired first image, wherein the appropriate playback is based on relevant marker information of the first image, and combined with parameter information of a current vehicle, such that the position information of the first image matches the position of the current vehicle.

### RELATED APPLICATIONS

This application claims the benefit of the Chinese patent application No. 201810332626.0 filed on Apr. 13, 2018, the entire disclosure of which is incorporated herein by reference.

### TECHNICAL FIELD

The disclosure relates to a vehicle assisted driving related technical field, and in particular, to an assisted driving method and apparatus, a computing device, a computer readable storage medium and a computer program product.

### BACKGROUND

presently, as the internet of vehicles is gradually increasing in popularity, the in-vehicle smart rearview mirrors become more frequently widely used, and the functions of driving recording, navigation and ADAS assisted driving are becoming increasingly popular. A camera installed on a vehicle may acquire a road condition image information in real time. However, when it comes to night driving or severe weather conditions, such as fog, haze, rain, snow, etc., the camera is affected by light, the ability of a user (e.g., a driver) to obtain image information in front is limited, and the problem of being blurred and unable to clearly see the road condition, especially a bend, fork, etc. in the road, in front is often encountered, which affects driving safety, and also brings difficulties in finding the intended destination.

In the process of implementing this application, the inventors have found that at least one or more of the following problems exists in the prior art: because of the weather such as rain and snow, fog and haze, sandstorm, etc. or low visibility of the road when driving at night or in a tunnel, or the line of sight of the driver being blocked due to construction, occlusion, etc., this results in that relevant problems of driving safety accident or difficulty in finding a destination or the like easily occur.

### SUMMARY

According to an embodiment of the disclosure, there is provided an assisted driving method including: acquiring a first image of a current road section, wherein in the first image is recorded road image information of the current road section; and controlling appropriate playback of the acquired first image, wherein the appropriate playback is based on relevant marker information of the first image, and combined with parameter information of a current vehicle, such that the position information of the first image matches the position of the current vehicle.

According to an embodiment, before the step of acquiring a first image of a current road section, there is further included determining the need for assisted driving.

According to an embodiment, the determining the need for assisted driving further includes steps of: detecting the clarity corresponding to the current line of sight of the current road section, judging whether the clarity is less than a preset clarity threshold, and determining the need for assisted driving for the current road section in response to the determination that the clarity is less than the preset clarity threshold.

According to an embodiment, the method further includes: timing the state in which the clarity is less than the preset clarity threshold in response to the determination that the clarity is less than the preset clarity threshold, judging whether the duration for which the clarity is less than the preset clarity threshold exceeds a preset time threshold, and determining the need for assisted driving for the current road section in response to the determination that the duration for which the clarity is less than the preset clarity threshold exceeds the preset time threshold.

According to an embodiment, the determining the need for assisted driving further includes steps of: detecting the position information of the current road section; acquiring road warning information based on the position information of the current road section, wherein the road warning information includes existing information labeling states of safety road conditions of different road sections; and determining whether the current road section needs assisted driving according to the acquired road warning information.

According to an embodiment, the first image contains the relevant marker information which includes one or more of the following different types of information: position information, clarity level information, lane information, time information, picture moving speed information of the first image as a video, and video duration information of the first image as a video.

According to an embodiment, the different types of information in the relevant marker information are preset with different priorities.

According to an embodiment, the step of acquiring a first image of a current road section includes: giving different weight coefficients to the different types of information in the relevant marker information according to the preset different priorities, respectively; multiplying parameter values corresponding to the different types of information in the relevant marker information of available images by corresponding weight coefficients, respectively, and obtaining the information matching degree by calculation; and selecting an available image with the highest information matching degree as the first image of the current road section.

According to an embodiment, the controlling appropriate playback of the acquired first image is implemented by the following algorithm,

$$Y ( Δ t ) = a * ( V ( t ) / ( \frac{1}{n} * {\sum }_{i = 1}^{n} Vi ( ti ) ) ) , \\ a = p 1 / p 2 ,$$

wherein Δt is a preset time period value of the first image, Y(Δt) is a video playback rate of the first image in the time period of Δt, p1 is a frame rate of video playback in the current vehicle, p2 is the frame rate of the first image itself, V(t) is a driving speed of the current vehicle at the moment of t, Vi(ti) is the picture moving speed of the first image when it is played normally, the moments t and ti˜tn are all in the time period of Δt, and a is a frame rate ratio coefficient for causing the first image to be adapted to the frame rate of video playback in the current vehicle.

According to an embodiment, controlling appropriate playback of the first image as a video is implemented by the following steps: setting multiple position synchronization points, determining playback nodes of the first image as a video corresponding to the position synchronization points, controlling the playback of the first image as a video in the vehicle, and playing at each of the position synchronization points according to a corresponding predetermined playback node.

According to an embodiment, there is further included: issuing a preset warning to the user in advance in response to the determining the need for assisted driving.

According to another embodiment of the disclosure, there is provided an assisted driving apparatus including: an image acquisition unit configured to acquire a first image of a current road section, wherein in the first image is recorded road image information of the current road section; a synchronous playback unit configured to control appropriate playback of the acquired first image, wherein the appropriate playback is based on relevant marker information of the first image, and combined with parameter information of a current vehicle, such that the position information of the first image matches the position of the current vehicle.

According to an embodiment, the apparatus further includes an assisted driving determination unit configured to determine the need for assisted driving.

According to an embodiment, the apparatus further includes a warning unit configured to issue a preset warning to a user in advance in response to that the assisted driving determination unit determines the need for assisted driving.

According to a further embodiment of the disclosure, there is provided a computing device including at least one processor and a storage communicatively connected with the at least one processor, wherein the storage stores an instruction which may be executed by the at least one processor, such that the at least one processor may perform the assisted driving method as described in one or more of the embodiments above.

According to an embodiment, before the step of acquiring a first image of a current road section, there is further included determining the need for assisted driving.

According to an embodiment, the determining the need for assisted driving further includes steps of: detecting the clarity corresponding to the current line of sight of the current road section, judging whether the clarity is less than a preset clarity threshold, and determining the need for assisted driving for the current road section in response to the determination that the clarity is less than the preset clarity threshold.

According to an embodiment, the method further includes: timing the state in which the clarity is less than the preset clarity threshold in response to the determination that the clarity is less than the preset clarity threshold, judging whether the duration for which the clarity is less than the preset clarity threshold exceeds a preset time threshold, and determining the need for assisted driving for the current road section in response to the determination that the duration for which the clarity is less than the preset clarity threshold exceeds the preset time threshold.

According to still another embodiment of the disclosure, there is provided a computer readable storage medium on which a computer executable instruction is stored, which instruction causes a computing device to implement the method of the one embodiment of the disclosure when executed by the computing device.

According to yet still another embodiment of the disclosure, there is provided a computer program product including a computer executable instruction, which instruction causes a computing device to implement the method of the one embodiment of the disclosure when executed by the computing device.

### BRIEF DESCRIPTION OF THE DRAWINGS

FIG. 1 is a flow diagram of an assisted driving method according to an embodiment of the disclosure.

FIG. 2 is a flow diagram of an assisted driving method according to an embodiment of the disclosure.

FIG. 3 is a flow diagram of an assisted driving method according to an embodiment of the disclosure.

FIG. 4 is a flow diagram of an assisted driving method according to an embodiment of the disclosure.

FIG. 5 is a flow diagram of an assisted driving method according to an embodiment of the disclosure.

FIG. 6 is a structural block diagram of an assisted driving apparatus according to an embodiment of the disclosure.

FIG. 7 is a hardware structure diagram of a device performing the assisted driving method according to embodiments of the disclosure.

### DETAILED DESCRIPTION

In the following the invention will be further described in detail in conjunction with specific embodiments and with reference to the drawings, to make the objects, technical solutions and advantages of the invention clearer.

It is noted that, all expressions using “first” in the embodiments of the disclosure are for differentiating between two non-identical entities or non-identical parameters with the same names, and clearly, “first” is just for the convenience of expression, and should not be understood as limiting the embodiments of the disclosure, which will not be explained one by one any longer in subsequent embodiments.

Mainly targeted at one or more of relevant problems of driving safety accident or difficulty in finding a destination or the like easily occurring because of the weather such as rain and snow, fog and haze, sandstorm, etc. or low visibility of the road when driving at night or in a tunnel, or the line of sight of a driver being blocked due to construction, temporary occlusion, etc., this results in that relevant problems, this application proposes a method for assisting a user (e.g., a driver) in driving safely and effectively utilizing the driving recording of a rearview mirror or an in-vehicle playback device. The particulars are as follows.

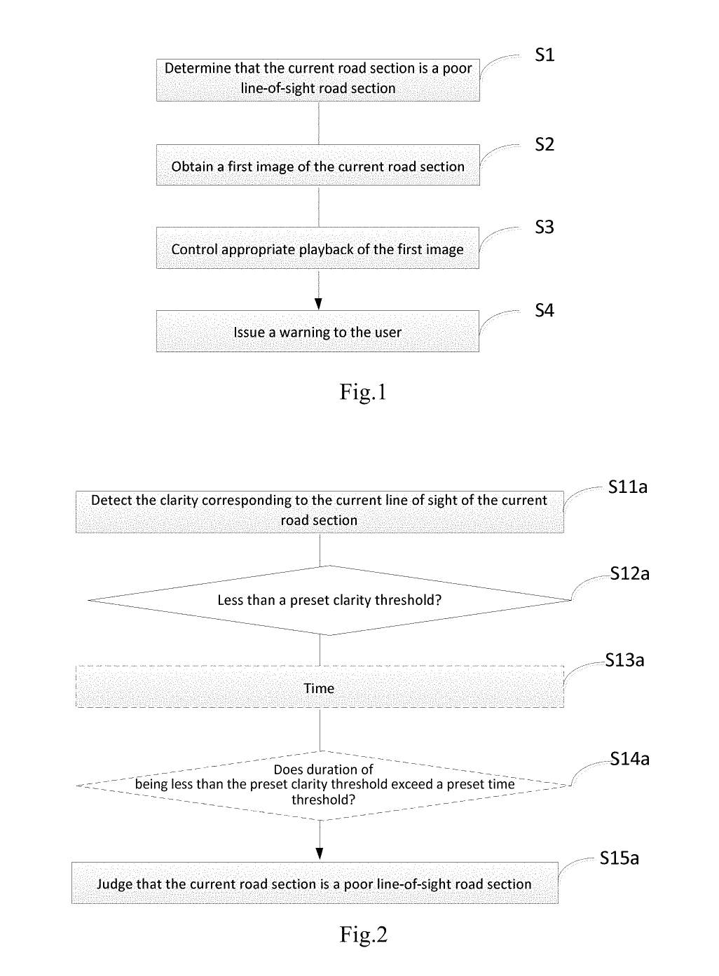

With reference to FIGS. 1-5, they are flow diagrams of an assisted driving method according to embodiments of the disclosure. It can be seen from FIGS. 1-5 that the assisted driving method includes one or more of the following steps.

At step S2, a first image of a current road section is acquired, wherein in the first image is recorded road image information of the current road section. That is, the basis of this solution is that it is needed to have already stored a first image corresponding to the current road section. In the example, the first image may be a video or image of a vehicle that passed the road section before taken under the circumstance of the line of sight not being blocked, which was then uploaded to a server or the cloud for storage, and it may also be a clear video recorded or a clear image taken by the government or a map navigation enterprise or the like utilizing a professional equipment, or an analog video or image constructed utilizing software. Of course, here, the path of acquiring the first image may be the local storage space of the vehicle, or also may be a server or the cloud communicatively connected with it. Here, the first image is not limited to the video format, and may also include other forms such as screenshot or photograph or the like.

In some exemplary embodiments, taking into account whether assisted driving is needed requires a certain predetermined condition, a step of performing corresponding judgment on the current road section is needed, and therefore, the assisted driving method described in this application further includes one or more of the following steps.

At step S1, the need for assisted driving is determined. This step may be accomplished by any of the following multiple embodiments.

In an embodiment, the line-of-sight condition of the current road section is detected and it is judged whether the current road section is a poor line-of-sight road section, and then the need for assisted driving is determined in response to the determination that the current road section is a poor line-of-sight road section, wherein the poor line-of-sight road section is a predefined road state not conducive to safe driving by a user, for example, a road in a case of low visibility such as rain and fog, fog and haze, sandstorm, night, tunnel, etc., or a road environment of a dangerous bend or prone to illusion, or a road section with construction ahead, with a temporary occlusion occluding the line of sight, or the like. Based on that there is an objective obstacle or obstacle potentially affecting subjectivity to the user's (e.g., driver's) perception of the road and the hidden danger of accidents is greatly increased under these circumstances, it is necessary to assist in driving.

As such, the step S1 of determining the need for assisted driving further includes one or more of the following steps.

At step S11a, the clarity corresponding to the current line of sight of the current road section is detected, wherein the clarity refers to a degree of clarity of a line-of-sight range in which the user (e.g., the driver) can observe. Generally, the clarity parameter of an in-vehicle camera, for example, the front-view camera of an in-vehicle rearview mirror, may be utilized, or a clarity detection algorithm is applied to an existing real-time video image, to be able to obtain the clarity c of the current video image.

At step S12a, it is judged whether the clarity is less than a preset clarity threshold, that is, the clarity c is compared with a preset clarity threshold V. If the clarity is less than the preset clarity threshold, c<V, it is indicated that the current line-of-sight condition of the current road section is poor. If the clarity is greater than or equal to the preset clarity threshold, it is indicated that the clarity is in an acceptable range, thereby determining that it may be possible not to start assisted driving.

Based on the misjudgment due to transient decrease in clarity that may occur in the process of detection, in an example, at step S13a, the state in which the clarity is less than the preset clarity threshold is timed in response to the judgment that the clarity is less than the preset clarity threshold. Afterwards, at step S14a, it is judged whether the duration for which the clarity is less than the preset clarity threshold exceeds a preset time threshold.

At step S15a, if the duration for which the clarity is less than the preset clarity threshold exceeds the preset time threshold, it is judged that the current road section is a poor line-of-sight road section and it is needed to assist in driving. If the duration does not exceed the preset time threshold, it is indicated that the line-of-sight condition being poor is accidental and does not represent that the current line-of-sight condition of the current road section is poor, and therefore there is no need to start assisted driving.

By judging the duration for which the clarity is less than the preset clarity threshold, it may be determined that the line-of-sight condition of the current road section is not a misjudgment resulting from a signal jump or instantaneous decrease in clarity, thereby achieving a relatively accurate judgment of the line-of-sight condition.

In another embodiment, the step S1 of determining the need for assisted driving includes one or more of the following steps.

As step S11b, the position information of the current road section is detected, wherein the position information is the position information corresponding to the road section where a current vehicle is, and in particular, the positioning of the position may be carried out by using an in-vehicle GPS or other positioning devices. The other positioning devices include, but not limited to, a Bluetooth transceiver communicating with a Bluetooth tag arranged on a road (for example, at a road lamp, a road sign, a signal lamp, etc.), a mobile phone around a user, which may support GPS positioning or also may be positioned based on the position of a base station to which it belongs, etc.

At step S12b, road warning information is acquired. Based on the position information of the current road section, the road warning information corresponding to the position information of the current road section may be acquired locally from the vehicle or a device on the vehicle, or from a platform (e.g., a server or the cloud, etc.) that can communicate with the vehicle or a device on the vehicle, wherein the road warning information is existing information labeling safety conditions of different road sections. Here, the road warning information labeling safety conditions of different road sections may be warning information about a dangerous road section or a poor line-of-sight road section (e.g., a sharp turn, a continuous bend, in which there is a fixed occlusion) made by the government or a map navigation company or the like, or also may be for example warning information uploaded by an individual (for example, uploaded to the server or the cloud) based on the driving experience of the vehicle (for example, after a safety accident happened or narrowly escaped a danger in the process of driving), and thus it may be such that it is only necessary for the current vehicle to learn about the road section where it is to be able to immediately know whether the current road section has warning information, or it may even know the warning information in advance before it arrives at the road section, without the need for on-the-spot judgment to start assisted driving, which avoids delay and helps to improve the safety and reliability of driving.

At step S13b, it is determined that the current road section is a poor line-of-sight road section and thereby determined that assisted driving is needed according to the acquired road warning information.

In still another embodiment, the step S1 of determining the need for assisted driving is very simple, that is, the need for assisted driving is determined once an instruction indicative of the need for assisted driving inputted by the user is received. This gives the user an interface for free judgment and/or selection, especially for example after the user artificially judges that the current road section belongs to a poor line-of-sight road section, or when the user wants to turn on assisted driving to make ready for accidents.

In some exemplary embodiments of the application, the first image at the step S2 is arranged with relevant marker information, and different types of information in the relevant marker information are preset with different priorities. As such, the step S2 of acquiring a first image of a current road section includes one or more of the following steps.

At step S21, the different types of information in the relevant marker information are given different weight coefficients according to the preset priorities, respectively, wherein the relevant marker information includes one or more of the following: position information, clarity level information, lane information, time information, picture moving speed information of the first image as a video, and video duration information of the first image as a video, etc. Of course, here, the relevant marker information may also be adjusted in terms of design accordingly as needed, for example, more information is added or some information is decreased, and it is not simply limited to what is listed above. For information that must be matched, for example, the position information, it may be set with a higher priority, and thereby set with a greater weight, and hence, the most matching first image may be screened out according to the relevant marker information, for example, the first image as a video of which the position matches, the lane is identical, the vehicle speed is close, the video duration is long.

At step S22, parameter values corresponding to the different types of information in the relevant marker information of available images are multiplied by corresponding weight coefficients, respectively, and the information matching degree is obtained by calculation.

At step S23, an available image with the highest information matching degree is selected as the first image of the current road section.

After the first image is acquired, at step S3, appropriate playback of the acquired first image is controlled. The appropriate playback may be based on relevant marker information of the first image, and combined with parameter information of the current vehicle, such that the position information of the first image matches the position of the current vehicle.

For example, when the first image is a video recorded on a mobile equipment, the appropriate playback may be based on the position information of the first image and combined with the position information and the vehicle speed information of the current vehicle, such that the position information of the first image matches the position information of the current vehicle, and the picture moving speed of the first image matches the vehicle speed of the current vehicle.

In an example, the controlling appropriate playback of the acquired first image is calculated by the following algorithm,

$$Y ( Δ t ) = a * ( V ( t ) / ( \frac{1}{n} * {\sum }_{i = 1}^{n} Vi ( ti ) ) ) ,$$

a=p1/p2, wherein Δt is a preset time period value for playing the acquired first image, Y(Δt) is a video playback rate of the first image in the time period of Δt, p1 is a frame rate of video playback in the current vehicle, p2 is the frame rate of the first image itself, V(t) is a driving speed of the current vehicle at the moment of t, Vi(ti) is the picture moving rate of the first image when it is played normally, the moments t and ti˜tn are all in the time period of Δt, and the frame rate ratio coefficient a is used for causing the first image to be adapted to the frame rate of video playback in the current vehicle.

It is noted that, since it may not be accomplished that the first image is acquired for playback control all the time in the process of vehicle driving the algorithm of the application sets a time coefficient Δt for staged adjustment and guaranteeing basic synchronization of the video playback. That is, in this application, assisted driving is performed by constantly acquiring videos of a length of the time period of Δt, wherein the value of Δt may be a numerical value set by the user, or also may be adjusted constantly. For example, if jam and pause appears in the process of controlling playback of the current video, it indicates that the action of acquiring videos is too frequent, and it is necessary to increase Δt, and otherwise, it may be possible to decrease Δt. However, for assisted driving, the less Δt is, the more precise the control will be, but still the higher the requirements for the network and device resources are. In the application, corresponding design adjustment may be performed on Δt by the trade-off between the control accuracy and the network and device resources.

That is, by the above synchronization algorithm, it causes that the position movement of the current vehicle keeps consistent with the picture movement in the first image as a video, and in turn causes that the surrounding environment of the current vehicle corresponds to the surrounding environment in the acquired first image, which may thus be helpful for the user (e.g., the driver) to acquire auxiliary information of the current road section from the first image and perform effective driving control on the current vehicle, and improve the safety of driving.

Preferably, in the above algorithm, since there may be a certain error in each Δt, it may be arranged such that position synchronization operation is performed at the initial node of each time period of Δt, and it is ensured that in a new time period of Δt, the position of a picture in the video at the initial moment of playback corresponds to the position of the current vehicle. From another point of view, the Δt is reflected as a distance 1 in space, that is, basic synchronization of video playback may be guaranteed by adjusting the distance 1.

As such, in an example, the step S3 of controlling appropriate playback of the first image as a video may be implemented by one or more of the following steps.

At step S31, multiple position synchronization points are set. The position synchronization points may be set according to a preset time interval based on the position information and the vehicle information of the current vehicle, for example, a position synchronization point is set per 0.5 seconds. Also, a space interval may be set according to the navigation precision utilizing the navigation position of the vehicle, for example, a position synchronization point is set per 10 meters. Of course, it is not excluded that they are set more densely for example in a complex area or a prosperous area or the like or in a case of a higher vehicle speed, whereas they are set more sparsely in an open area or in a case of a slower vehicle speed. Thus, position synchronization with the played first image may be implemented at each position synchronization point, to maintain position synchronization.

At step S32, playback nodes of the first image as a video corresponding to the position synchronization points are determined. For a case in which the first image is a video, playback nodes of the video corresponding to the position synchronization points may be obtained based on the position information and the speed information of picture movement of the acquired video.

At step S33, the playback of the video in the vehicle is controlled, and the playback is done at each of the position synchronization points according to a corresponding predetermined playback node. That is, when the current vehicle passes a set position synchronization point, the playback node corresponding to the position synchronization point will be controlled to ensure that the picture position in the video corresponds to the current position of the current vehicle, and improve the availability of assisted driving.

In some exemplary embodiments of the application, the assisted driving method further includes step S4, wherein if the current road section is a poor line-of-sight road section, a warning may be issued to the user. For example, the user is prompted by way of voice broadcast, in-vehicle screen or rearview mirror display or the like. The warning may be made based on the above-mentioned warning information, or also may be made based on the above result that a poor line-of-sight road section has been detected. The warning may be made utilizing an existing device of the current vehicle.

The acquired first image in the application may be previewed and played utilizing an existing device in the vehicle such as a common smart rearview mirror, etc., and also it may be determined whether assisted driving is needed by current line-of-sight information acquired by an existing device in the vehicle such as a driving recorder, etc. This approach may implement assisted driving without increasing any hardware cost, help the user to master the current environment, and is conducive to improving driving safety.

It can be seen from the above embodiments that in the assisted driving method provided by the application, by monitoring the current road section, and further by acquiring an existing first image when a poor line-of-sight road section appears, and in turn based on the acquired first image and in combination with parameter information of the current vehicle, video playback is controlled, such that the picture position in the video corresponds to the current position of the current vehicle, which realizes the synchronization of the video playback and the position of the current vehicle. Thus, the user (e.g., the driver) may obtain or even obtain in advance the line-of-sight information corresponding to the current road section by viewing pictures in the first image, which avoids a hidden danger due to the poor line-of-sight. Therefore, the application can provide a user with effective assistance in a condition of bad road line of sight, and reduce the occurrence of safety accidents of a user (e.g. a driver) due to the line of sight being blocked.

The numbering and early or late description of the above steps does not necessarily represent their order, and they may be performed in any possible reasonable order. For example, the step S4 may take place after the step S1 and before the step S2, or also may take place at the same time with the step S2 or S3.

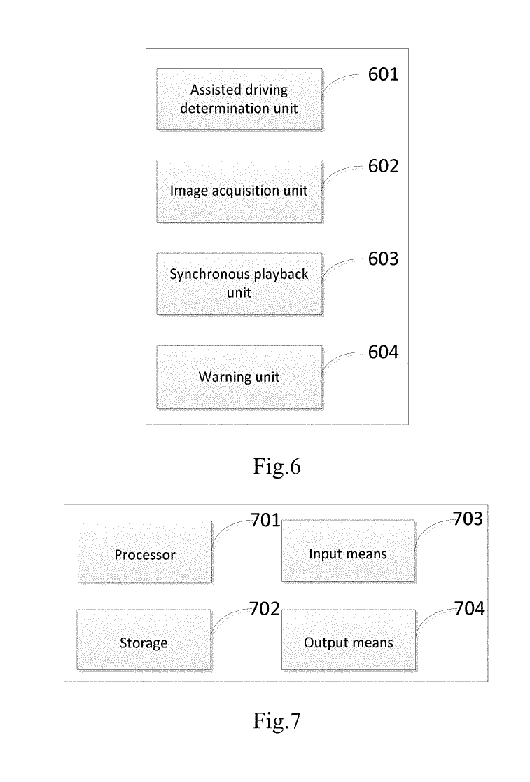

With reference to FIG. 6, it is a structural block diagram of an assisted driving apparatus according to an embodiment of the disclosure. It can be seen from FIG. 6 that the assisted driving apparatus includes an image acquisition unit 602 and a synchronous playback unit 603.

The image acquisition unit 602 is configured to acquire a first image of a current road section, wherein in the first image is recorded road image information of the current road section. For a specific way of acquisition, it may be referred to the above description about the steps S2 and S21-S23, which will not be repeated here any longer.

The synchronous playback unit 603 is configured to control appropriate playback of the first image acquired by the image acquisition unit 602. The appropriate playback may be based on relevant marker information of the first image, and combined with parameter information of a current vehicle, such that the position information of the first image matches the position of the current vehicle. For a specific way of playback control, refer to the above description of the steps S3, S31-S33, which will not be repeated here any longer.

In some exemplary embodiments of the application, the assisted driving apparatus further includes an assisted driving determination unit 101 configured to determine the need for assisted driving. For a specific way of determination, it may be referred to the above description about the steps S1 and S11a-S15a, and the steps S11b-S13b, which will not be repeated here any longer.

Since the assisted driving apparatus has features corresponding to the assisted driving method, it naturally has the same effects, which will not be repeated here any longer.

It is noted that, the acquired first image in the application may be previewed and played utilizing an existing device in the vehicle such as a common smart rearview mirror, etc., and also it may be determined whether assisted driving is needed by current line-of-sight information acquired by an existing device in the vehicle such as a driving recorder, etc. This approach may implement assisted driving without increasing any hardware cost, help the user to master the current environment, and is conducive to improving driving safety.

Further, in an example, the acquired first image and the current line-of-sight information actually taken by the driving recorder may be split-screen displayed on the screen of the rearview mirror, which is helpful for a user or a device to judge whether assisted driving is needed by comparison, and may provide a warning. In addition, a portion of the front part of the vehicle or the lower part of the vehicle which is blocked by the body of the vehicle may be displayed by a HUD. The acquired line-of-sight information behind the vehicle may be displayed on the rear windshield by the HUD to remind a rear vehicle to prevent rear-end collision.

The image acquisition unit, the synchronous playback unit, the assisted driving determination unit and the warning unit may for example be implemented by one or more processor such as one or more digital signal processor (DSP), universal microprocessor, application-specific integrated circuit (ASIC), field programmable gate array (FPGA) or other equivalent integrated or discrete logic circuit or the like. In addition, the functionalities of these units may be completely implemented in one or more circuit or logic element. The above various units may be combined or provided by a collection of interoperable hardware units (including one or more processor as described above) in combination with suitable software and/or firmware.

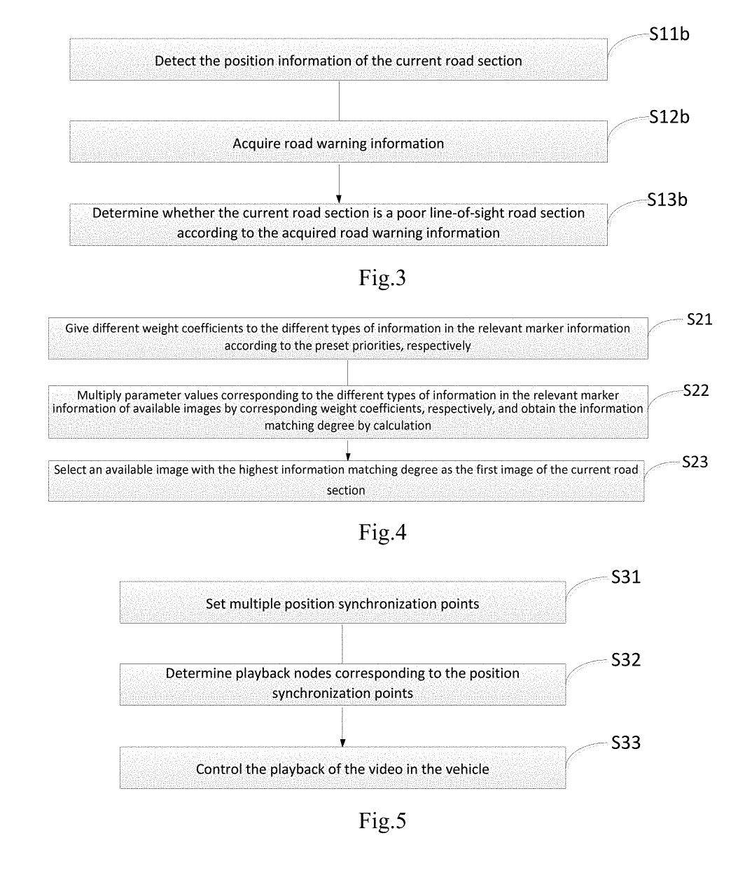

With reference to FIG. 7, it is a hardware structure diagram of a device performing the assisted driving method according to embodiments of the disclosure. The device includes at least one processor 701 and a storage 702. In FIG. 3, one processor 701 is taken as an example.

The device performing the assisted driving method may further include an input means 703 and an output means 704.

The processor 701, the storage 702, the input means 703 and the output means 704 may be mutually connected via bus or other means.

As a non-volatile computer readable storage medium, the storage 702 may be used for storing a non-volatile software program, a non-volatile computer executable program and module, for example, a program instruction/module corresponding to the assisted driving method in the embodiments of the application. The processor 701 performs various functional applications and data processing of a server by running the non-volatile software program, instruction and module stored in the storage 702, namely, implements the assisted driving method of the above method embodiments.

The storage 702 may include a storage program area and a storage data area, wherein the storage program area may store an operating system, an application program required for at least one function, and the storage data area may store data created according to the use of the assisted driving apparatus, etc. In addition, the storage 702 may include a high-speed random access memory, or also may include a non-volatile storage, for example, at least one disk storage device, flash device or other non-volatile solid storage devices. In some embodiments, the storage 702 exemplarily includes a storage arranged remotely relative to the processor 701, which may be connected to the assisted driving apparatus via a network. Examples of the network include, but not limited to, the internet, intranet, local area network, mobile communication network and a combination thereof.

The input means 703 may receive inputted digit or character information, and generate a key signal input related with the user settings and the functional control of the assisted driving apparatus. The output means 704 may include a video presentation device such as a display screen, etc. or an audio presentation means such as a speaker, etc.

The one or more module is stored in the storage 702, and when executed by the one or more processor 701, performs the assisted driving method in any of the method embodiments.

The above products may perform the method provided by the embodiments of the application, and have corresponding functional modules performing the method and beneficial effects. The technical details not described in detail in the embodiments may be referred to the method provided by the embodiments of the application.

The electronic devices of the embodiments of the disclosure exist in multiple forms, including, but not limited to,

(1) mobile communication devices, of which the characteristics are having mobile communication functions and taking provision of voice and data communication as the main goal, and which include smart mobile phones (e.g., iPhone), multimedia mobile phones, functional mobile phones and low-end mobile phones, etc.

(2) ultra mobile PC devices, which belong to the category of PCs, have calculation and processing functions, and generally also have characteristics of mobile internet access, and which include PDA, MID and UMPC devices, etc, for example, iPad.

(3) portable entertainment devices, which may display and play multimedia content, and include audio and video players (e.g., iPod), handheld game machines, electronic books and smart toys and portable in-vehicle navigation devices.

(4) servers, which are devices providing computing services, of which the composition includes a processor, a hard disk, a memory, a system bus, etc., of which the architecture is similar to that of a general-purpose computer, but for which the requirements for processing power, stability, reliability, security, scalability and manageability, etc. are higher because of the need for providing services of high reliability.

(5) other electronic apparatuses with data interaction functions.

It should be appreciated by the person having ordinary skills in the art that, the discussion of any of the above embodiments is only exemplary, and is not intended to imply that the scope of the disclosure (including the claims) is limited to these examples, and in the concept of the invention, the above embodiments or the technical features in different embodiments may also be combined, the steps may be realized in any order, and many other changes of the different embodiments of the invention as described above exist, which are not provided in detail for simplicity.

In addition, for simplifying description and discussion, and in order not to make the invention difficult to understand, well-known power/ground connections with an integrated circuit (IC) chip and other components may be or may not be shown in the provided drawings. In addition, apparatuses may be shown in the form of block diagram, to avoid making the invention difficult to understand, and this also considers the fact that the implementation details about these block diagram apparatuses highly depend on a platform which will implement the invention (that is, these details should be completely within the understanding of the person having skills in the art). In a case in which particular details (e.g., circuits) have been set forth to describe the exemplary embodiments of the invention, it is evident to the person having skills in the art that the invention may be implemented without these particular details or with these particular details being changed. Therefore, the description should be considered illustrative rather than limiting.

Although the invention has been described in conjunction with the specific embodiments of the invention, many alternatives, modifications and variations of these embodiments will be obvious to the person having ordinary skills in the art according to the foregoing description. For example, other storage architectures (e.g., a dynamic RAM (DRAM)) may use the discussed embodiments.

The embodiments of the disclosure are intended to cover all such alternatives, modifications and variations which fall within the broad scope of the appended claims. Therefore, within the spirit and principles of the invention, any omissions, modifications, equivalent substitutions, improvements, etc. that are made should all be encompassed in the protection scope of the invention.

1. An assisted driving method comprising:
acquiring a first image of a current road section, wherein in the first image is recorded road image information of the current road section; and
controlling an appropriate playback of the acquired first image, wherein the appropriate playback is based on relevant marker information of the first image, and combined with parameter information of a current vehicle, such that the position information of the first image matches the position of the current vehicle.

2. The method as claimed in claim 1, wherein before the step of acquiring a first image of a current road section, there is further comprises:
determining the need for assisted driving.

3. The method as claimed in claim 2, wherein the step of determining the need for assisted driving further comprises steps of:
detecting a clarity corresponding to the current line of sight of the current road section,
judging whether the clarity is less than a preset clarity threshold, and
determining the need for assisted driving for the current road section in response to the determination that the clarity is less than the preset clarity threshold.

4. The method as claimed in claim 3, further comprising:
timing a state in which the clarity is less than the preset clarity threshold in response to the determination that the clarity is less than the preset clarity threshold,
judging whether the duration for which the clarity is less than the preset clarity threshold exceeds a preset time threshold, and
determining the need for assisted driving for the current road section in response to the determination that the duration for which the clarity is less than the preset clarity threshold exceeds the preset time threshold.

5. The method as claimed in claim 2, wherein the determining the need for assisted driving further comprises steps of:
detecting the position information of the current road section,
acquiring road warning information based on the position information of the current road section, wherein the road warning information includes existing information labeling states of safety road conditions of different road sections, and
determining whether the current road section needs assisted driving according to the acquired road warning information.

6. The method as claimed in claim 1, wherein the first image contains the relevant marker information which includes one or more of the following different types of information:
position information, clarity level information, lane information, time information, picture moving speed information of the first image as a video, and video duration information of the first image as a video.

7. The method as claimed in claim 6, wherein the different types of information in the relevant marker information are preset with different priorities.

8. The method as claimed in claim 7, wherein the step of acquiring a first image of a current road section comprises:
giving different weight coefficients to the different types of information in the relevant marker information according to the preset different priorities, respectively,
multiplying parameter values corresponding to the different types of information in the relevant marker information of available images by corresponding weight coefficients, respectively, and obtaining the information matching degree by calculation, and
selecting an available image with the highest information matching degree as the first image of the current road section.

9. The method as claimed in claim 1, wherein the controlling appropriate playback of the acquired first image is implemented by the following algorithm,
$$Y ( Δ t ) = a * ( V ( t ) / ( \frac{1}{n} * {\sum }_{i = 1}^{n} Vi ( ti ) ) ) , \\ a = p 1 / p 2 ,$$
wherein Δt is a preset time period value of the first image, Y(Δt) is a video playback rate of the first image in the time period of Δt, p1 is a frame rate of video playback in the current vehicle, p2 is the frame rate of the first image itself, V(t) is a driving speed of the current vehicle at the moment of t, Vi(ti) is the picture moving speed of the first image when it is played normally, the moments t and ti˜tn are all in the time period of Δt, and a is a frame rate ratio coefficient for causing the first image to be adapted to the frame rate of video playback in the current vehicle.

10. The method as claimed in claim 1, wherein controlling appropriate playback of the first image as a video is implemented by the following steps:
setting multiple position synchronization points,
determining playback nodes of the first image as a video corresponding to the position synchronization points,
controlling the playback of the first image as a video in the current vehicle, and playing at each of the position synchronization points according to a corresponding predetermined playback node.

11. The method as claimed in claim 1, further comprising: issuing a preset warning to a user in advance in response to the determining the need for assisted driving.

12. An assisted driving apparatus comprising:
an image acquisition unit configured to acquire a first image of a current road section, wherein in the first image is recorded road image information of the current road section,
a synchronous playback unit configured to control appropriate playback of the acquired first image, wherein the appropriate playback is based on relevant marker information of the first image, and combined with parameter information of a current vehicle, such that the position information of the first image matches the position of the current vehicle.

13. The apparatus as claimed in claim 12, further comprising:
an assisted driving determination unit configured to determine the need for assisted driving.

14. The apparatus as claimed in claim 12, further comprising:
a warning unit configured to issue a preset warning to a user in advance in response to that the assisted driving determination unit determines the need for assisted driving.

15. A computing device comprising:
at least one processor, and
a storage communicatively connected with the at least one processor, wherein
the storage stores an instruction which may be executed by the at least one processor, such that the at least one processor may perform a method as claimed in claim 1.

16. The computing device as claimed in claim 15, wherein before the step of acquiring a first image of a current road section, there is further comprised:
determining the need for assisted driving.

17. The computing device as claimed in claim 16, wherein the determining the need for assisted driving further comprises steps of:
detecting a clarity corresponding to the current line of sight of the current road section,
judging whether the clarity is less than a preset clarity threshold, and
determining the need for assisted driving for the current road section in response to the determination that the clarity is less than the preset clarity threshold.

18. The computing device as claimed in claim 17, the method further comprises:
timing a state in which the clarity is less than the preset clarity threshold in response to the determination that the clarity is less than the preset clarity threshold,
judging whether the duration for which the clarity is less than the preset clarity threshold exceeds a preset time threshold, and
determining the need for assisted driving for the current road section in response to the determination that the duration for which the clarity is less than the preset clarity threshold exceeds the preset time threshold.

19. A computer readable storage medium on which a computer executable instruction is stored, which instruction causes a computing device to implement a method as claimed in claim 1 when executed by the computing device.

20. A computer program product comprising a computer executable instruction, which instruction causes a computing device to implement a method as claimed in claim 1 when executed by the computing device.
